(19) United States
(12) Patent Application Publication
(10) Pub. No.: US 2004/0156585 A1
(43) Pub. Date: Aug. 12, 2004

(54) Lensed fiber for optical interconnections

(76) Inventors: Kristen Matusick, Bath, NY (US); John R. Saltzer JR., Beaver Dams, NY (US); Terry L. Taft, (US); Ljerka Ukrainczyk, Painted Post, NY (US); Debra L. Vastag, Elmira Heights, NY (US)

Correspondence Address: CORNING INCORPORATED, SP-TI-3-1, CORNING, NY, 14831

(21) Appl. No.: 10/733,921

(22) Filed: Dec. 11, 2003

Related U.S. Application Data
(63) Continuation-in-part of application No. 10/319,748, filed on Dec. 13, 2002, now abandoned.
(60) Provisional application No. 60/486,087, filed on Jul. 9, 2003.

(51) Int. Cl. G02B 6/32

(52) U.S. Cl. 385/33

(57) ABSTRACT

A lensed fiber includes an optical fiber and a lens having a neck region and a convex region formed at an end of the optical fiber. The neck region has an overall diameter that is smaller than an outer diameter of the optical fiber. In one embodiment, the neck region is tapered.

### CROSS-REFERENCE TO RELATED APPLICATIONS

This application is a continuation-in-part of U.S. patent application Ser. No. 10/319,748, entitled “Lensed Fiber for Optical Interconnections,” filed Dec. 13, 2002. This applications claims priority to U.S. Provisional Application 60/486,087, entitled “Lensed Fiber for Optical Interconnections,” filed Jul. 9, 2003.

### BACKGROUND OF INVENTION

The invention relates generally to optical interconnections. More specifically, the invention relates to a lensed fiber capable of refracting light coming into and out of an optical fiber into a collimated or focused beam and to a method of making the lensed fiber.

A lensed fiber is a monolithic device having an optical fiber that is terminated with a lens. Lensed fibers are advantageous because they do not require active alignment and bonding of the optical fiber to the lens, they have low insertion loss, and they enable component miniaturization and design flexibility. Lensed fibers are easily arrayed and are therefore desirable for making arrayed devices such as variable optical attenuators and optical isolators, for use in silicon optical bench applications, for use as high power connectors and dissimilar fiber connectors, and for coupling optical signals into other micro-optic devices. In addition, the spot size and working distance of a lensed fiber can be tailored for a specific application. For example, the spot size and working distance of a lensed fiber can be tailored to produce the smaller beam diameters that can allow use of smaller micro-electro-mechanical systems (MEMS) mirrors in optical switches.

FIG. 1A shows a prior-art lensed fiber 100 having a lens 102 spliced to an optical fiber 104. The lens 102 has a convex region 106 that refracts light coming out of the optical fiber 104 into a collimated or focused beam. The lens 102 has a neck region 108 that connects the convex region 106 to the optical fiber 104. The diameter of the neck region 108 is larger than the outer diameter of the optical fiber 104, resulting in the overall diameter of the lensed fiber 100 being greater than the outer diameter of the optical fiber 104. Hence, the lensed fiber 100 would not be able to fit into a standard glass or ceramic ferrule or groove, such as an etched groove on a silicon chip, designed to hold the optical fiber 104. Instead, a specialized ferrule or groove would have to be designed to hold the lensed fiber 100. As can be appreciated, the lens 102 can have a wide range of geometries, and designing a specialized ferrule or groove to hold each lens geometry would be difficult and not cost-effective.

FIG. 1B shows a prior-art lensed fiber 110 having a lens 114 spliced to an optical fiber 112. The lens 114 has convex region 118 that refracts light coming out of the optical fiber 112 into a collimated or focused beam. The lens 114 has a neck region 116 having a diameter that is equivalent to the outer diameter of the optical fiber 112. If the radius of curvature (Rc) of the convex region 118 is greater than half of the outer diameter of the optical fiber 112, the overall diameter of the lens 114 would be greater than the outer diameter of the optical fiber 112, resulting in the overall diameter of the lensed fiber 110 being larger than the outer diameter of the optical fiber 112. In this case, the lensed fiber 110 would not fit into a standard glass or ceramic ferrule or groove, such as an etched groove on a silicon chip, designed to hold the optical fiber 112. Instead, as previously discussed, a specialized ferrule or groove would have to be designed to hold the lensed fiber 110.

Theoretically, it would be expected that if the radius of curvature of the convex region 118 is less than or equal to half the outer diameter of the optical fiber 112 and the diameter of the neck region 116 is equivalent to the outer diameter of the optical fiber 112, then the overall diameter of the lens 114 would not exceed the outer diameter of the optical fiber 112. However, in practice, this is usually not the case. The process used in forming the radius of curvature at the tip of the lens often results in the lens having a match-stick shape and an overall diameter that is larger than the outer diameter of the optical fiber. FIG. 1C shows a lensed fiber 120 having a lens 122 with a match-stick shape. The match-stick shape results in the overall diameter of the lensed fiber 120 being slightly larger than the outer diameter of the optical fiber 124, even though the radius of curvature of the convex region 126 of the lens 120 is smaller than half the outer diameter of the optical fiber 124.

Typically, a bulge is also formed at the splice junction between the lens and optical fiber which can increase the overall diameter of the lensed fiber. For example, FIG. 1C shows a bulge 128 formed at the splice 130 between the lens 122 and the optical fiber 124 as a consequence of the splicing process. The bulge 128 results in the overall diameter of the lensed fiber 120 being slightly larger than the outer diameter of the optical fiber 124, even though the diameter of the neck region 132 of the lens is equivalent to the outer diameter of the optical fiber 124. Because of the bulge 128 at the splice 130 and the match-stick shape of the lens 122, the lensed fiber 120 may not be able to fit into a standard glass or ceramic ferrule or in a groove, such as an etched groove on a silicon chip, designed to hold the optical fiber 124. In addition, the bulge 128 makes it difficult to maintain straight alignment of the lensed fiber 120 in a groove, such as an etched groove on a silicon chip.

From the foregoing, there is desired a lensed fiber that is capable of refracting light coming into and out of an optical fiber into a collimated or focused beam and that can be cost-effectively packaged in a standard design ferrule or groove configuration.

### SUMMARY OF INVENTION

In one aspect, the invention relates to a lensed fiber which comprises an optical fiber and a lens having a neck region and a convex region formed at an end of the optical fiber. The neck region has an overall diameter that is smaller than an outer diameter of the optical fiber.

In another aspect, the invention relates to a method of making a lensed fiber which comprises splicing a coreless fiber to an optical fiber. The coreless fiber has a diameter smaller than an outer diameter of the optical fiber. The method further includes controllably applying heat and axial tension to the coreless fiber to form a lens having a neck region and a convex region. The neck region has an overall diameter that is smaller than the outer diameter of the optical fiber.

In another aspect, the invention relates to a method of making a lensed fiber which comprises splicing a coreless fiber to an optical fiber, cleaving the coreless fiber to a desired length, and melting back the cleaved end of the coreless fiber to form a lens having a radius of curvature at its tip and an overall diameter that does not exceed the outer diameter of the optical fiber. The coreless fiber has a diameter that is smaller than an outer diameter of the optical fiber.

In another aspect, the invention relates to a method of making a lensed fiber which comprises splicing a coreless fiber to an optical fiber, wherein the coreless fiber has a diameter that is equal to or larger than an outer diameter of the optical fiber. The method further includes controllably applying heat and axial tension to the coreless fiber until the diameter of the coreless fiber becomes smaller than the outer diameter of the optical fiber and taper-cutting the coreless fiber to form a lens having a neck region and a convex region. The neck region has a diameter that is smaller than the outer diameter of the optical fiber.

Other features and advantages of the invention will be apparent from the following description and the appended claims.

### BRIEF DESCRIPTION OF DRAWINGS

FIG. 1A shows a prior-art lensed fiber having a lens with a neck region that is larger in diameter than the optical fiber to which the lens is attached.

FIG. 1B shows a prior-art lensed fiber having a lens with a neck region that is equivalent in diameter to the optical fiber to which the lens is attached.

FIG. 1C shows a prior-art lensed fiber having a lens with a match-stick shape.

FIG. 2 shows a lensed fiber having a lens with a neck region that is smaller in diameter than the optical fiber to which the lens is attached according to one embodiment of the invention.

FIG. 3A illustrates an alignment step of a method of making a lensed fiber according to one embodiment of the invention.

FIG. 3B illustrates a fusion-splicing step of a method of making a lensed fiber according to one embodiment of the invention.

FIG. 3C illustrates a taper-cutting step of a method of making a lensed fiber according to one embodiment of the invention.

FIG. 3D shows the lensed fiber after the taper-cutting step illustrated in FIG. 3C.

FIG. 3E illustrates a melt-back step of a method of making a lensed fiber according to one embodiment of the invention.

FIG. 4A shows mode field diameter as a function of lens thickness and radius of curvature for a single-mode fiber at 1550 nm for an embodiment of the invention.

FIG. 4B shows distance to beam waist as a function of lens thickness and radius of curvature for a single-mode fiber at 1550 nm for an embodiment of the invention.

FIG. 4C shows the nomenclature used for the lens geometries shown in FIGS. 4A and 4B.

FIG. 5A shows a coreless fiber having a cleaved end fusion-spliced to an optical fiber.

FIG. 5B shows the cleaved end of the coreless fiber of FIG. 5A rounded into a desired radius of curvature according to another embodiment of the invention.

FIG. 6 shows a lensed fiber having a lens formed from a coreless fiber that initially has a diameter that is larger than the outer diameter of the optical fiber to which the lens is attached.

FIG. 7 shows a lensed fiber having a lens with a tapered neck region according to another embodiment of the invention.

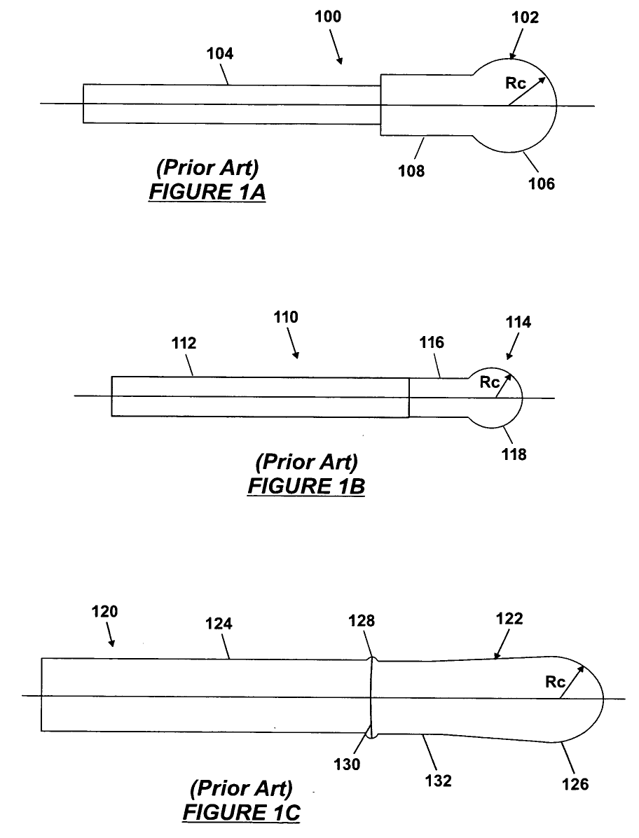

### DETAILED DESCRIPTION OF PREFERRED EMBODIMENTS

The invention will now be described in detail with reference to a few preferred embodiments, as illustrated in accompanying drawings. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to not unnecessarily obscure the invention. The features and advantages of the invention may be better understood with reference to the drawings and discussions that follow.

Embodiments of the invention provide a lensed fiber having a lens disposed at an end of an optical fiber. The lens has a convex region and a neck region, and the neck region has an overall diameter that is smaller than the outer diameter of the optical fiber. In some embodiments, the neck region is straight. In other embodiments, the neck region is tapered. By making the overall diameter of the neck region smaller than the outer diameter of the optical fiber, the convex region of the lens can be made with a wide range of prescriptions without the overall diameter of the lens exceeding the outer diameter of the optical fiber. As a result, the lensed fiber can be packaged in standard glass or ceramic ferrules or grooves, such as grooves etched on silicon chips, or other receptacles designed to hold the optical fiber.

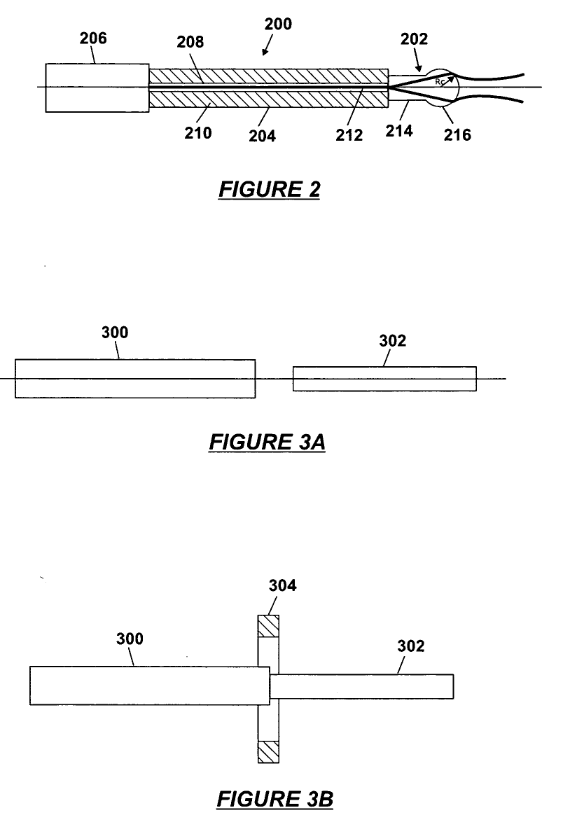

FIG. 2 shows a lensed fiber 200 according to an embodiment of the invention. The lensed fiber 200 includes a planoconvex lens 202 disposed at an end of an optical fiber 204. The lens 202 may be attached to the optical fiber 204 by a fusion splicing process or other suitable attachment process, e.g., by an index-matched epoxy. In general, fusion splicing would produce a more robust connection between the lens 202 and the optical fiber 204. In one embodiment, the optical fiber 204 is a stripped region of a coated optical fiber (or pigtail) 206. The optical fiber 204 has a core 208 and a cladding 210 surrounding the core 208. The optical fiber 204 could be any single-mode fiber, including polarization-maintaining (PM) fiber, or a multimode fiber. In operation, a light beam 212 traveling down the core 208 diverges upon entering the lens 202 and is refracted into a collimated or focused beam upon exiting the lens 202. Whether the beam emerging from the lens 202 is collimated or focused depends on the ratio of the thickness of the lens to the radius of curvature of the lens.

The lens 202 has a neck region 214 and a convex region 216. The lens 202 is made from a coreless fiber having a diameter that is smaller than the outer diameter of the optical fiber 204, resulting in the neck region 214 having a diameter that is smaller than the outer diameter of the optical fiber 204. The cross-section of the neck region is typically circular but could also have other shapes, e.g., rectangular. Therefore, the term “diameter” of the neck region is intended to refer to a dimension, usually the largest dimension, at a cross-section of the neck region. A lens having a neck region with a diameter that is smaller than the outer diameter of the optical fiber to which it is attached provides packaging and manufacturing advantages compared to a lens having a neck region with a diameter that is the same as or larger than the outer diameter of the optical fiber to which it is attached.

Typically, the coreless fiber used in making the lens 202 is made of silica or doped silica, e.g., B₂O₃—SiO₂ and GeO₂—SiO₂, and has a refractive index similar to the refractive index of the core 208 of the optical fiber 204. The coefficient of thermal expansion of the lens 202 can be matched to that of the optical fiber 204 to achieve better performance over a desired temperature range. The lens 202 may be coated with an anti-reflection coating to further reduce back-reflection loss. A back-reflection loss lower than −55 dB is generally desirable.

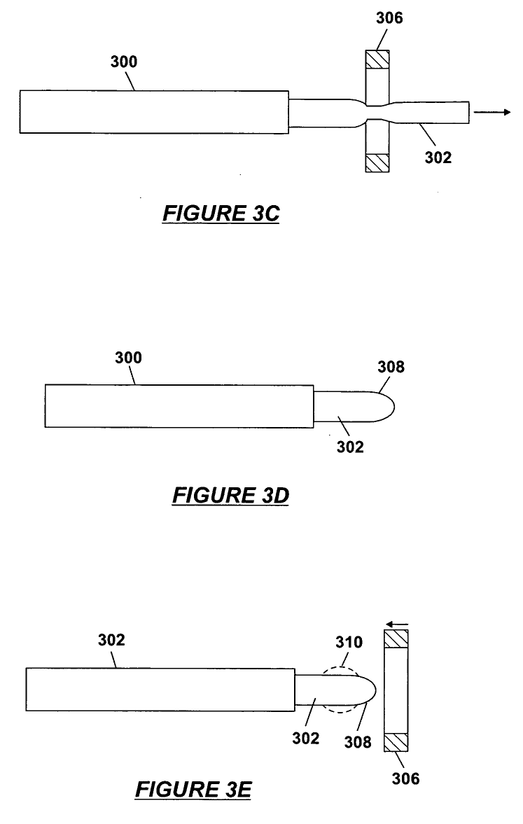

A method of making a lensed fiber, such as described in FIG. 2, will now be described with reference to FIGS. 3A-3D. In FIG. 3A, the method starts with aligning the axial axis of an optical fiber 300 to the axial axis of a coreless fiber 302. In this method, the coreless fiber 302 will be attached to the optical fiber 300 and shaped into a planoconvex lens having a neck region and a convex region. In order to allow the diameter of the neck region to be smaller than the outer diameter of the optical fiber 300, the diameter of the coreless fiber 302 is selected to be smaller than the diameter of the optical fiber 300. After aligning the axial axes of the optical fiber 302 and the coreless fiber 302, the opposing ends of the optical fiber 300 and coreless fiber 302 are brought together, as shown in FIG. 3B, and are spliced together using a heat source 304. The heat source 304 may be a resistive filament or other suitable heat source, such as an electric arc or laser.

After splicing the coreless fiber 302 to the optical fiber 300, the coreless fiber 302 is taper-cut to a desired length. As shown in FIG. 3C, taper-cutting involves positioning a heat source 306 at a desired location along the coreless fiber 302. The position of the heat source 306 along the coreless fiber 302 determines the thickness of the lens. The heat source 306 is then operated to deliver a controlled amount of heat to the coreless fiber 302 while pulling the coreless fiber 302 in the direction indicated by the arrow. The heating and pulling actions cut the coreless fiber 302 to a desired length. Further, as shown in FIG. 3D, a convex surface 308 having a desired radius of curvature is formed at the distal end of the coreless fiber 302. When a resistive filament is used as the heat source (306 in FIG. 3C) the heat distribution along the circumference of the coreless fiber 302 is very uniform, allowing for the formation of a spherical convex surface with a symmetrical mode field.

The radius of curvature of the convex surface 308 depends on the power output of the heat source (306 in FIG. 3C). Typical power used for taper-cutting the coreless fiber 302 using a resistive filament is in a range from 22 to 30 W, depending on the desired radius of curvature. The radius of curvature of the convex surface 308 can also be affected by the duration of heating. In general, the longer the heating time after the coreless fiber 302 is severed, the larger the radius of curvature. The radius of curvature that can be achieved with the taper-cutting process alone is small, typically between 5 μm and 60 μm. However, this radius of curvature can be enlarged by a melt-back process. As shown in FIG. 3E, the melt-back process involves placing the heat source 306 in front of the convex surface 308 and moving the heat source 306 towards the convex surface 308. The convex surface 308 is melted back by the heat to form a larger radius of curvature, as indicated by the dotted lines 310. The heat applied to the convex surface 308 and the duration of the heating are controlled to obtain the desired radius of curvature.

By using taper-cutting and melting-back processes for the lensed fiber formation, it is possible to make a lens with a radius of curvature (Rc) that is less than or equal to half of the outer diameter of the optical fiber without the diameter of the lens exceeding the diameter of the optical fiber. The maximum lens thickness is determined by clipping of the beam at the apex of the lens:

$${T}_{max} = \frac{D}{π \cdot tan ( \frac{λ}{π \cdot {w}_{o}} )} \qquad ( 1 )$$

where D is 2×Rc, λ is wavelength in the lens material, and wₒ is the mode field radius of the optical fiber at the splice to the lens. To produce a diffraction-limited beam, i.e., a beam with a single peak, the radius of curvature at the tip of the lens should not be smaller than the mode field radius of the optical fiber at the splice to the lens.

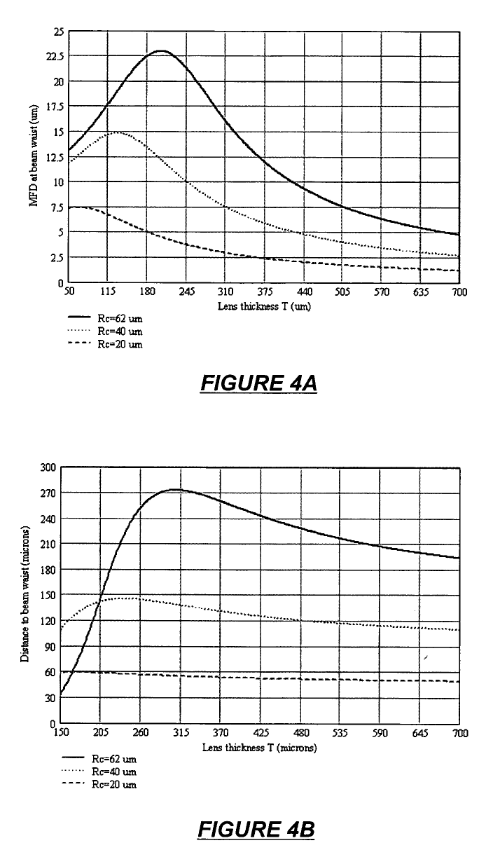

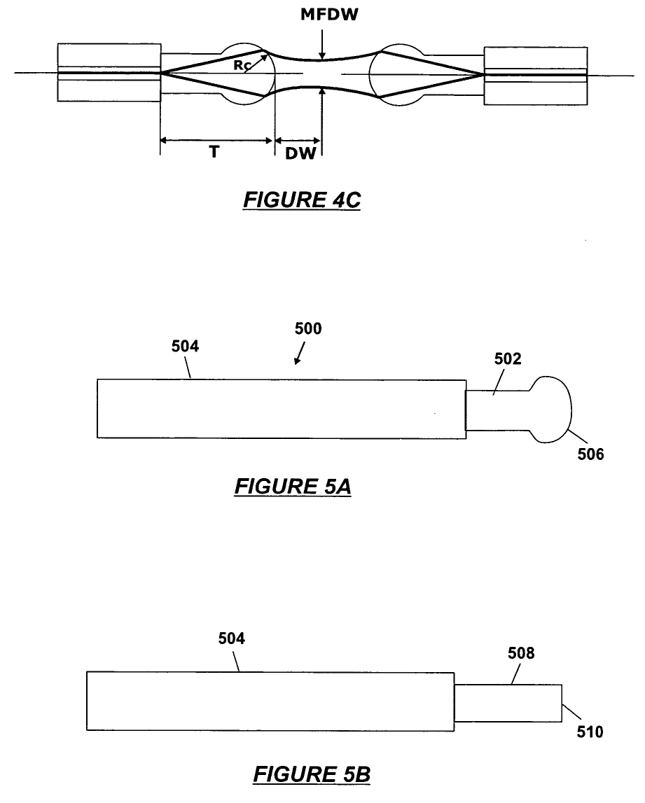

FIGS. 4A and 4B show examples of lens geometries that can be made with a single mode fiber, such as Corning SMF-28® optical fiber, having an outer diameter of 125 μm. FIG. 4A shows a plot of mode field diameter at beam waist (MFDW in FIG. 4C) at 1550 nm as a function of lens thickness and radius of curvature (Rc) of the convex surface at the tip of the lens. FIG. 4B shows a plot of distance to beam waist (DW in FIG. 4C) at 1550 nm as a function of lens thickness and Rc of the convex surface at the tip of the lens. For a single mode fiber having an outer diameter of 125 μm, the lens can be made to have a maximum possible Rc of 62.5 μm without the overall diameter of the lens exceeding the outer diameter of the optical fiber. In these examples, the maximum thickness of the lens if made from silica and operating at free space wavelength of 1550 nm (D=125 μm, wₒ=6 μm) is 697 μm.

For a lensed fiber made by taper-cutting and melting-back, if Rc of the lens is greater than half of the OD of the optical fiber, the overall diameter of the lens will be greater than the outer diameter of the optical fiber. In this case, making the lens from a coreless fiber with a diameter that is smaller than the outer diameter of the optical fiber still has packaging and manufacturing advantages compared to making the lens from a coreless fiber with a diameter that is equal to or larger than the outer diameter of the optical fiber. With a coreless fiber having a diameter equivalent to the outer diameter of the optical fiber, a bulge is created on the splice between the optical fiber and the coreless fiber, as previously discussed. With a coreless fiber having a diameter larger than the outer diameter of the optical fiber, the amount of energy required to cut the coreless fiber is larger. By using a smaller-diameter coreless fiber, it is possible to reduce the power output required to form the lens. Because of the smaller volume of the glass, the heat transfer is more uniform than with a larger-diameter coreless fiber, so the effects of asymmetry of heat source has lesser impact. The centering of the curvature of the lens with respect to the core of the optical fiber is also accomplished more successfully using a smaller volume of glass.

FIG. 5A shows a lensed fiber 500 according to another embodiment of the invention. The lensed fiber 500 includes a lens 502 that is attached to an optical fiber 504. The lens 502 has a convex surface 506. The lensed fiber 500 is formed by fusion-splicing a coreless fiber (508 in FIG. 5B) to the optical fiber 504 and cleaving the coreless fiber to a desired length by, for example, a mechanical or laser cleaver. The cleaved end (510 in FIG. 5B) essentially has an infinite radius of curvature. A melt-back process, such as described above, can then be used to form any radius of curvature (Rc) at the cleaved end. Unlike the method described above which starts the melt-back with a smaller Rc than the final lens Rc, this method starts melt-back with an infinite Rc that is decreased by the heating process. Thus, this method does not require the convex surface 506 to be a full sphere. In this case, a convex surface with Rc greater than half of the outer diameter of the optical fiber 504 can be made without the overall diameter of the lens exceeding the outer diameter of the optical fiber 504.

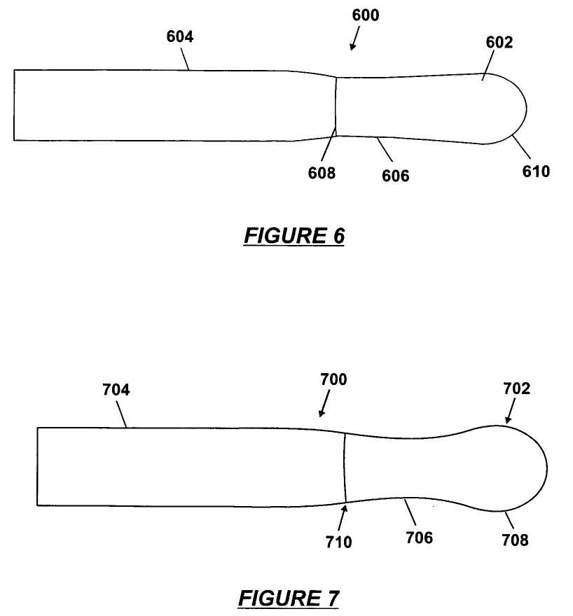

FIG. 6 shows a lensed fiber 600 according to another embodiment of the invention. The lensed fiber 600 includes a lens 602 disposed at an end of an optical fiber 604. In this embodiment, the lens is formed from a coreless fiber having a diameter that is larger than or equal to the diameter of the optical fiber 604. The lensed fiber is formed by aligning and fusion-splicing the coreless fiber to the optical fiber 604. The coreless fiber is then pulled in a direction away from the optical fiber such that the resultant neck region 606 of the lens 602 would exhibit a diameter that is smaller than the diameter of the optical fiber 604. This pulling action also eliminates any bulge at the splice 608 between the optical fiber 604 and the coreless fiber. The coreless fiber is then taper-cut at a desired location to form the convex surface 610. A melt-back process may be used to enlarge the radius of curvature of the convex surface 610, as previously described.

For the lensed fiber 600, the radius of curvature of the convex surface 610 that can be formed without the overall diameter of the lens 602 exceeding the outer diameter of the optical fiber 604 is relatively small. For example, for an optical fiber having an OD of 125 μm, the overall diameter of the lens 602 starts to exceed the overall diameter of the optical fiber 604 when the Rc of the lens 602 is greater than about 53 μm. For an optical fiber having an OD of 125 μm, the thickness of the lens 602 is also limited to about 250 μm. Above this limit, the overall diameter of the lens 602 starts to exceed the overall diameter of the optical fiber 604.

FIG. 7 shows a lensed fiber 700 according to another embodiment of the invention. The lensed fiber 700 includes a lens 702 disposed at an end of an optical fiber 704. The lens 702 has a neck region 706 and a convex region 708. In this embodiment, the neck region 706 is tapered. In one embodiment, the lens 702 is formed from a coreless fiber that is smaller in diameter than the optical fiber 704. The coreless fiber is aligned to the optical fiber, and a splice is formed between the coreless fiber and the optical fiber 704 using a fusion process. The coreless fiber is then stretched in a direction away from the optical fiber 704 while heat is applied along the coreless fiber, including the splice region. The heat may be applied using a resistive filament or other suitable heat source. The heating and stretching actions taper the coreless fiber and smoothen the splice region, as shown at 710. The heating and stretching actions may include cutting the coreless fiber to a desired length. Heat is applied to the distal end of the coreless fiber, i.e., the end farthest from the optical fiber 704, to allow surface tension to pull the distal end of the coreless fiber into a convex surface, as shown at 708.

For illustration purposes, Table 1 shows calculated properties of lensed fibers similar to the one shown in FIG. 7. For lensed fiber A, a coreless fiber having a diameter of 100 μm was spliced to an optical fiber having an outer diameter of 125 μm. For lensed fiber B, a coreless fiber having a diameter of 200 μm was spliced to an optical fiber having an outer diameter of 125 μm. Lenses were formed at the end of the coreless fibers using the processes previously described. Lensed fibers having a pointing error less than 0.5 μm (or pointing angle less than 0.5°) were selected. The radius of curvature of the lenses was approximately 62 μm, and the thickness of the lenses was approximately 285 μm. The lens properties shown in Table 1 are calculated assuming free-space wavelength of 1550 nm. The low back-reflection loss is achieved without use of AR coating. With AR coating, back-reflection loss of −55 dB or lower may be achieved.

TABLE 1

| | Mode Field | Distance to | Back-reflection |
|---|---|---|---|
| Lensed | Diameter | Beam Waist | Loss |
| Fiber | (μm) | (μm) | (no AR, dB) |
| A | 13 ± 1.5 | 260 ± 10 | −43 |
| B | 16 ± 1.5 | 260 ± 10 | −40 |

The invention provides one or more advantages. A lensed fiber such as disclosed herein with a lens having an overall diameter that is the same as or smaller than the diameter of the optical fiber can be easily packaged into a standard glass or ceramic fiber ferrule. The lens can be inserted directly into the ferrule without having to thread the pigtail through the ferrule. The lens can also be easily arrayed or placed into a standard multi-fiber ferrule. The lens can also be easily packaged into V-grooves or other etched structures on silicon chips or other semiconductor platforms. The invention provides an ideal lens for small optical MEMS switches, VOAs, and silicon optical bench applications.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A lensed fiber, comprising:
an optical fiber; and
a lens having a neck region and a convex region formed at an end of the optical fiber, the neck region having an overall diameter smaller than an outer diameter of the optical fiber.

2. The lensed fiber of claim 1, wherein an overall diameter of the lens does not exceed the outer diameter of the optical fiber.

3. The lensed fiber of claim 2, wherein a radius of curvature of the convex region does not exceed half the outer diameter of the optical fiber.

4. The lensed fiber of claim 3, wherein the outer diameter of the optical fiber is approximately 125 μm.

5. The lensed fiber of claim 4, wherein the radius of curvature of the convex region does not exceed approximately 62.5 μm.

6. The lensed fiber of claim 5, wherein a maximum thickness of the lens is approximately 697 μm.

7. The lensed fiber of claim 4, wherein the radius of curvature of the convex region does not exceed approximately 53 μm.

8. The lensed fiber of claim 7, wherein a maximum thickness of the lens is approximately 250 μm.

9. The lensed fiber of claim 2, wherein a radius of curvature of the convex region is greater than half the outer diameter of the optical fiber.

10. The lensed fiber of claim 1, wherein the radius of curvature of the convex region is not smaller than a mode field radius at a splice formed between the optical fiber and the neck region.

11. The lensed fiber of claim 2, wherein the neck region is tapered.

12. The lensed fiber of claim 1, wherein a back-reflection loss of the lens is −40 dB or lower without anti-reflection coating.

13. The lensed fiber of claim 1, wherein a back-reflection loss of the less is −55 dB or lower with anti-reflection coating.

14. The lensed fiber of claim 1, wherein a mode field diameter at beam waist of the lens is approximately 13±1.5 μm.

15. The lensed fiber of claim 1, wherein a mode field diameter at beam waist of the lens is approximately 16±1.5 μm

16. The lensed fiber of claim 1, wherein a distance to beam waist of the lens is approximately 260±10 μm.

17. The lensed fiber of claim 1, wherein a pointing error of the lens is less than 0.5 μm.

18. A method of making a lensed fiber, comprising:
splicing a coreless fiber to an optical fiber, the coreless fiber having a diameter smaller than an outer diameter of the optical fiber; and
controllably applying heat and axial tension to the coreless fiber to form a lens having a neck region and a convex region, the neck region having an overall diameter smaller than the outer diameter of the optical fiber.

19. The method of claim 18, further comprising enlarging a radius of curvature of the convex region by melting back the convex region.

20. The method of claim 19, wherein the radius of curvature of the convex region and the thickness of the lens are such that an overall diameter of the lens does not exceed the outer diameter of the optical fiber.

21. The method of claim 20, wherein the radius of curvature of the convex region does not exceed half the outer diameter of the optical fiber.

22. The method of claim 18, wherein controllably applying heat and axial tension to the coreless fiber comprises tapering the coreless fiber.

23. The method of claim 22, wherein tapering the coreless fiber comprises smoothening a region surrounding the splice formed between the coreless fiber and the optical fiber.

24. The method of claim 22, wherein the diameter of the optical fiber is approximately 125 μm.

25. The method of claim 24, wherein the diameter of the coreless fiber is approximately 100 μm.

26. The method of claim 18, wherein controllably applying heat and axial tension to the coreless fiber comprises cutting the coreless fiber to a desired length and applying heat to a distal end of the coreless fiber so that surface tension pulls the distal end into a convex surface.

27. A method of making a lensed fiber, comprising:
splicing a coreless fiber to an optical fiber, the coreless fiber having a diameter smaller than an outer diameter of the optical fiber;
cleaving the coreless fiber to a desired length; and
melting back the cleaved end of the coreless fiber to form a lens having a radius of curvature at its tip and an overall diameter that does not exceed the outer diameter of the optical fiber.

28. The method of claim 27, wherein the radius of curvature at the tip of the lens is equal to larger than an outer diameter of the optical fiber.

29. A method of making a lensed fiber, comprising:
splicing a coreless fiber to an optical fiber, the coreless fiber having a diameter equal to or larger than an outer diameter of the optical fiber;
controllably applying heat and axial tension to the coreless fiber until the diameter of the coreless fiber becomes smaller than the outer diameter of the optical fiber; and
taper-cutting the coreless fiber to form a lens having a neck region and a convex region, the neck region having a diameter smaller than the outer diameter of the optical fiber.

30. The method of claim 29, further comprising enlarging a radius of curvature of the convex region by melting back the convex region.

31. The method of claim 30, wherein the radius of curvature of the convex region and a thickness of the lens are such that an overall diameter of the lens does not exceed the outer diameter of the optical fiber.

32. The method of claim 29, wherein controllably applying heat and axial tension eliminates any bulge at the splice formed between the coreless fiber and the optical fiber.
